(19) United States
(12) Patent Application Publication
(10) Pub. No.: US 2008/0222115 A1
(43) Pub. Date: Sep. 11, 2008

(54) Software system and interface for database searching

(76) Inventor: Robert Darel Bonds, Redmond, WA (US)

Correspondence Address: LAW OFFICE OF POLLY L. OLIVER, 3134 Parkside Circle NE, Tacoma, WA, 98422, US

(21) Appl. No.: 12/070,948

(22) Filed: Feb. 21, 2008

Related U.S. Application Data
(60) Provisional application No. 60/890,987, filed on Feb. 21, 2007.

(51) Int. Cl. G06F 17/30

(52) U.S. Cl. 707/3; 707/E17.014

(57) ABSTRACT

A flexible user interface allows a user to build a search request using common English vernacular so that the user does not need to know or understand database wildcards and other operators—which can vary from software to software. Once the user has built his search request, the computer search software processes the search criteria through several algorithms to return the exact information sought. The search results are then displayed in the output portion of the user interface in a user-friendly format, typically in list form that can be printed in a report if desired.

### RELATED APPLICATIONS

This application is related to and claims priority under 35 U.S.C. 119(e) to U.S. provisional application Ser. No. 60/890,987, entitled “Software System and Interface for Database Searching” filed on Feb. 21, 2007, having the same inventor Robert Bonds of Redmond, Wash., which is hereby incorporated by reference in its entirety.

### FIELD OF THE INVENTION

This invention pertains generally to software and more particularly to a new and advanced software system and interface for searching a computerized database.

### BACKGROUND OF THE FIELD

Computerized databases are searched for a variety of reasons by many different versions of existing search software. The user enters values for the search parameters and reviews the returned results. A problem with these existing systems, however, is that they do not provide sufficiently accurate data in the results so that the user is forced to refine the search to find precisely the information that is sought, and this may result in two or more iterations of searching. Another problem is that in order to make good use of the search software, the user must know and be familiar with typical search pattern operators and searching methods. These problems make existing search systems less than optimum for a wide range of potential users.

Some patents and patent applications have dealt with these problems to varying degrees of success. For instance, Cox in US Pat. App. 2007/0255683 discloses a search system that refines the search based on the first set of returned results. Although some of Cox's refining may be done internally “behind the scenes,” as are the Applicant's algorithms, it is still refining and therefore not a resolution to the problem. Lavi in Pat. App. 2007/0266019 discloses a software system that helps the user build a specific search request as the Applicant does. However, unlike the Applicant's invention, Lavi's system uses a related terms generator which is not present in the Applicant's invention.

Other patent references are directed specifically towards car lot administration. Shishido in U.S. Pat. No. 7,184,974 discloses a searching system used for finding a particular desired car in a used car lot. Although this search system contains some similar database fields, e.g., the ones for vehicle information, it is intended for a different purpose, i.e., purchasing used cars, and also comprises a step of searching and reporting on price research information.

Some patent references in the prior art comprise searching systems for car lots; however, are primarily intended for sales support to the salesperson (in the way of scripts and other information). These references, such as Brockman in U.S. Pat. No. 6,125,356, Woytowick in US Pat. App. No. 2006/0155614, and Green in U.S. Pat. No. 6,041,310 focus on the sales and marketing aspects instead of the searching aspect.

### SUMMARY OF THE INVENTION

The present invention solves the above-mentioned problems by providing a simple and effective database searching system for managing a search request for a user comprising a flexible user interface to be used in searching a database as well as computer processing means to process the request and storage means for storing the database information. This flexible user interface and the associated software will return precise data results the first time so that the user does not need to spend time refining the search to find the information sought. The user also does not need to understand complex or obscure database wildcards, which can vary from database to database in existing search systems.

One embodiment of the invention comprises a user interface for entering field parameters and parameter values and then viewing the returned information in a result set as well as the associated search software that comprises various software algorithms that operate on the entered values to find and return the found information. The interface is structured so that the user does not need to understand complex search parameters but can nevertheless create a (broad or narrow) specific search request using vernacular English language to construct his own search criteria. The behind-the-scenes software then processes the data according to the entered parameters, and the software algorithms automatically create search commands which include field and pattern operators. The search software applies a plurality of these pattern operators to the database fields in order to return exact search results to the user.

Although it is understood that the invention could be applied to many different uses and types of databases, such as a library of cataloged books or a college offering many types of classes, one specific use of this invention may be for administration of an impound car lot. In this case, the database may comprise fields regarding not only vehicle data such as make, model, year, and color, but also other relevant data such as owner data, dispatch data, legal data, and/or property data. The interface will provide the user with opportunities to input as much information to identify the desired vehicle (or range of vehicles) as is known or desired. After the software algorithms have performed to find the desired information, the interface displays the information in a user-friendly format that includes exact and precise information about the vehicle(s) and may also include the vehicle's location in the car lot.

### BRIEF DESCRIPTION OF THE DRAWINGS

The objects, features, and advantages of the present invention will be apparent to one skilled in the art from reading the following description in which:

FIG. 1 is basic flowchart showing how the field data is entered into fields on the database and stored on a storage device;

FIG. 2 is a top level flowchart showing the invention of the search software and database;

FIG. 3 is a detail view of a possible input interface menu screen;

FIG. 4 is a detail view of a possible search request;

FIG. 5 is a detail view of another possible input interface menu screen;

FIG. 6 is a top level flowchart showing an alternate embodiment of the invention;

FIG. 7 is an alternate depiction of a flowchart showing the invention; and

FIG. 8 is a possible interface screen.

### DETAILED DESCRIPTION

The following specification describes a software system and interface for database searching according to the present invention. In the description, specific materials and configurations are set forth in order to provide a more complete understanding of the present invention. But it is understood by those skilled in the art that the present invention can be practiced without those specific details. In some instances, well-known elements are not described precisely so as not to obscure the invention.

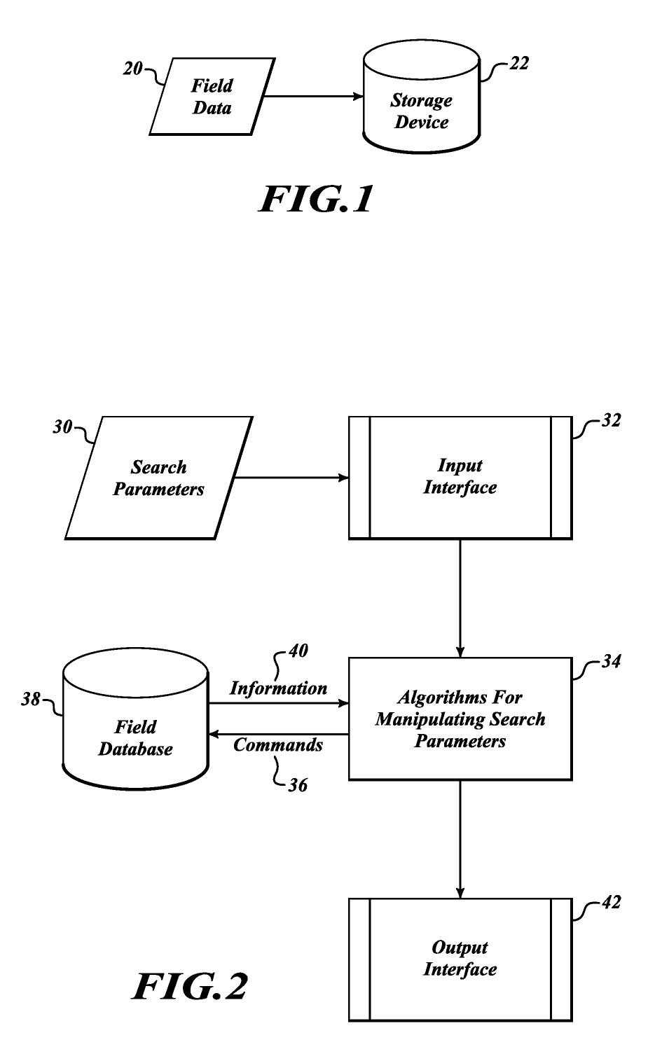

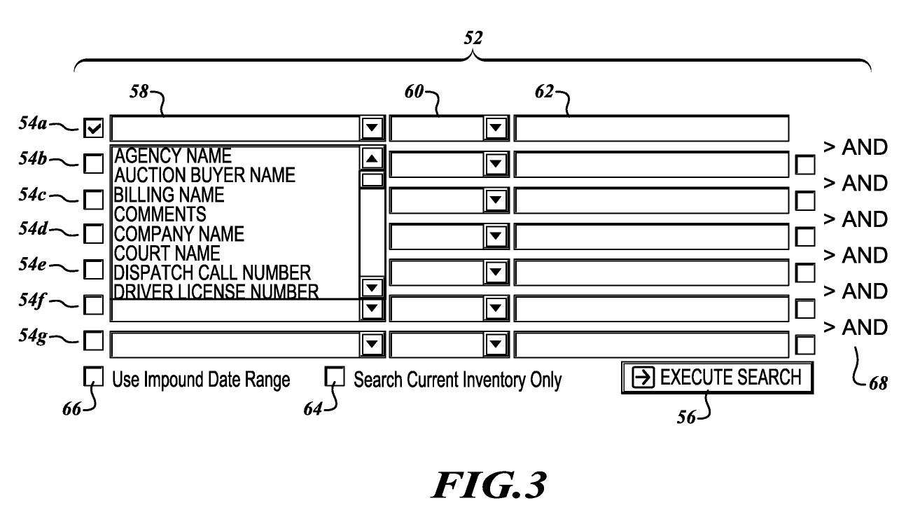

FIG. 1 shows in simple flowchart form how the field data 20 is to be input into the database on the storage device 22. The field data may comprise several detailed items of information and in a preferred embodiment contains 45 different database fields. In this preferred embodiment and in the specific example shown, the invention is applied to managing an impound car lot, and so the 45 database fields include agency name, auction buyer name, billing name, comments, company name, court name, dispatch call number, and driver license number—as shown in the drop-down menu of FIG. 3. Obviously, there is no upper limit to the number of database fields, and indeed, the power of the invention increases dramatically with that number, because the algorithms are streamlined to return precise information regardless of the size of the database or the amount of input criteria.

FIG. 2 shows a top level flowchart of the invention, having a first means for entering search request parameters, here a flexible user interface—which is divided into input interface and output interface—and second means for manipulating the search parameters, here the associated software that uses a plurality of algorithms to manipulate the search request parameters. The search parameters 30 are entered by the user into the input interface 32. The process 34 uses algorithms to manipulate the search parameters into commands 36 and then execute those commands to operate on the field database 38 which will deliver information 40 back to the process 34 so that the third means for returning the search results to the user, here an output interface 42 can display the user's search results in a user-friendly output interface with a user-friendly format.

FIG. 3 shows detail of a drop-down menu 50 from the input interface 52 from which the user can begin to construct his own search request. In the preferred embodiment, that of a car lot administration application, the menu may comprise seven input rows 54a, 54b, 54c, 54d, 54e, 54f, and 54g that can be customized by the user. Obviously, a different number of rows could be designed into the interface, but seven has been chosen here as a reasonable number for car lot application. In this example, each input row contains three input fields (any appropriate number other than three could be chosen), for database field, pattern operator, and free text respectively. Such input fields could be presented in any order; however, the order of the illustrations has been chosen to make the interface as user-friendly as possible. Obviously, with a different number of input fields per input row, a different order may be chosen.

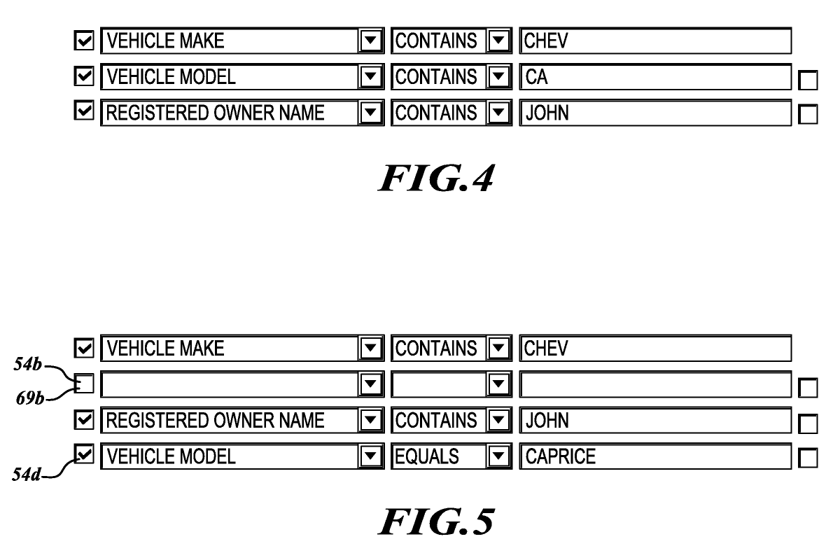

After the user has made a database field choice from the drop-down menu for the first input field 58, he may make a pattern operator choice for the second input field 60 from another drop-down menu. Typically, the database field choices presented in the drop-down menu are representative only and might not be the same code names as the associated database fields in the stored database. Typically, the pattern operator choices may be ‘exact match,’ ‘is not,’ or ‘contains,’ as is shown in the following FIG. 4. The user then completes his search request by typing his search text string into the third input ‘free text’ field 62. Such string may contain whole or partial words or any meaningful alphanumeric characters.

When activated by clicking on the Execute Search button 56, these rows work together to form a complex search query behind the scenes. In order to generate the search command, at least one of the algorithms of the process will conjoin the input rows according to a predetermined—or a user-determined—row operator. In a basic embodiment, the row operator 68 may be predetermined by the process and typically is the operator AND (as is shown in the illustrated examples). (However, any other appropriate operator such as OR or BUT NOT may be used.) This is typically done behind the scenes so that the user does not have to understand such operators. In a more advanced embodiment, intended for use by more advance users, the row operator may be user defined. This allows for a more powerful and complex search request, but also demands more knowledge and searching familiarity from the user.

Upon forming the complex search query and generating the commands, the algorithms of the process of the second means continue to execute those commands by searching the database and manipulating the database information according to the commands in order to produce the search results. In a preferred embodiment, that of the illustrations, the algorithms are presented as one comprehensive subroutine. However, as is described later in this specification, the process code could be divided into different portions depending, e.g., on the function of the algorithms.

By way of example, FIG. 4 shows a possible search request. This user has chosen to search on the three database fields of vehicle make, vehicle model, and registered owner name. The user has chosen the pattern operator ‘contains’ in order to broaden his search. The user then typed his desired text string into the third input field as shown. The process then applies the row operator ‘AND’ and proceeds to search the database. The result set from this search request would include all CHEVrolet models that contain ‘CA’ (including corsiCA, el CAmino, CAprice, monte CArlo, CAvalier, and CAmaro) with a registered owner containing ‘John’ (including JOHN, JOHNson, JOHNsen, etc.). The user has the option at the initial search request to further restrict the result set by searching only what is in inventory (by checking the Search Current Inventory Only button 64 as shown in FIG. 3) and by an impound date range (by checking the Use Impound Date Range button 66 shown in FIG. 3).

FIG. 5 shows another flexible feature of the user interface for the car lot administration version. Search criteria items can be saved to use later by simply deactivating the appropriate row, such as the second row 54b, by unchecking the row's activation box 69b. In this case, the user has chosen to activate a fourth row 54d, and the search request shown will return only CHEVrolet CAPRICES with a registered owner name containing JOHN.

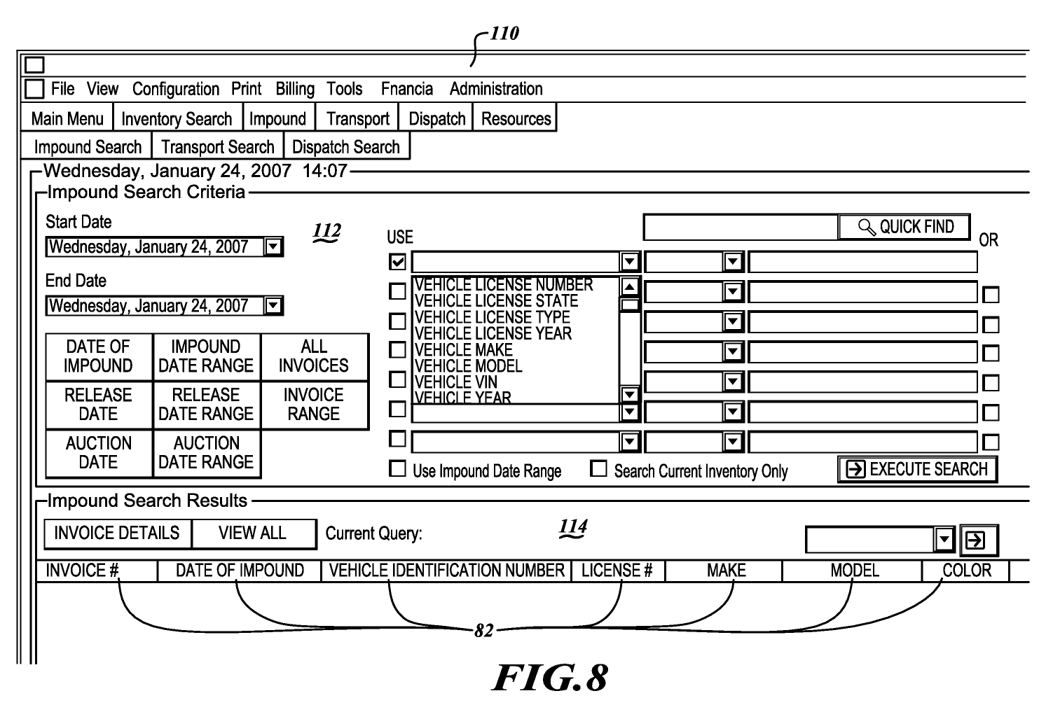

The software invention will return the result set as a display in the output user interface in a user-friendly format such as a list whose headings 82 are shown in FIG. 8. In this third means for returning the search results to the user, the headings 82 will typically be the database fields that were chosen by the user in the input rows of the input interface. Alternatively, the headings 82 could be predetermined by the software in order to keep more control over the results set and to present the results in a user-friendly language and form. With this list, a user can view one particular search result item in detail or the entire result set in detail including precise and exact descriptions of the found data. Additionally, the user has the option to load the result set into a report—allowing for custom reporting on demand. The combined flexibility of the advanced searching capabilities and the reporting capabilities makes this software invention both powerfully effective and extremely efficient.

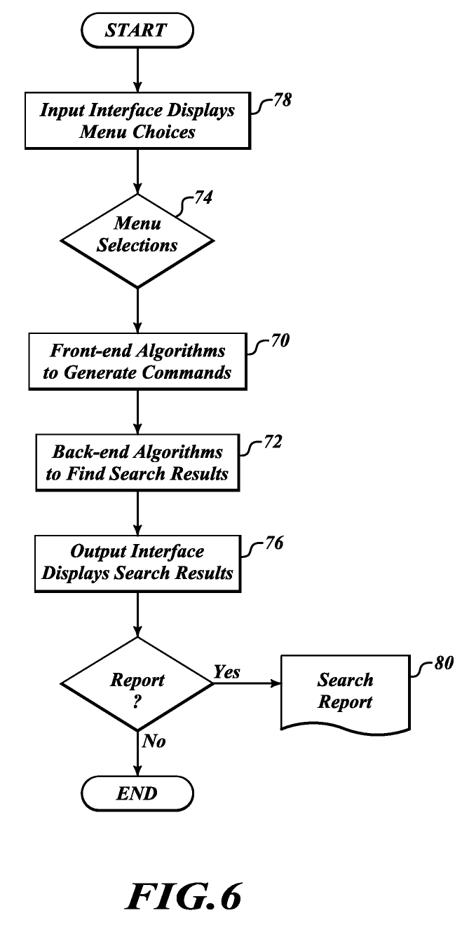

FIG. 6 shows how the process subroutines of the search software may be divided into front-end algorithms 70 and back-end algorithms 72. In this alternate embodiment, the front-end portion 70 may be used to manipulate the entered search parameters and pattern and row operators—as represented here by the menu selections 74—to generate search commands for the database, and the back-end portion 72 may be used to apply the commands to operate on the stored data of the database to find and produce results in the database. The results are then displayed in the output interface 76 as described above. Both the input interface 78 and the output interface 76 may be shown together on one screen for the review of the user, as shown in FIG. 8. As already explained, the user will then have the option of loading the search parameters and results into a printable search report 80.

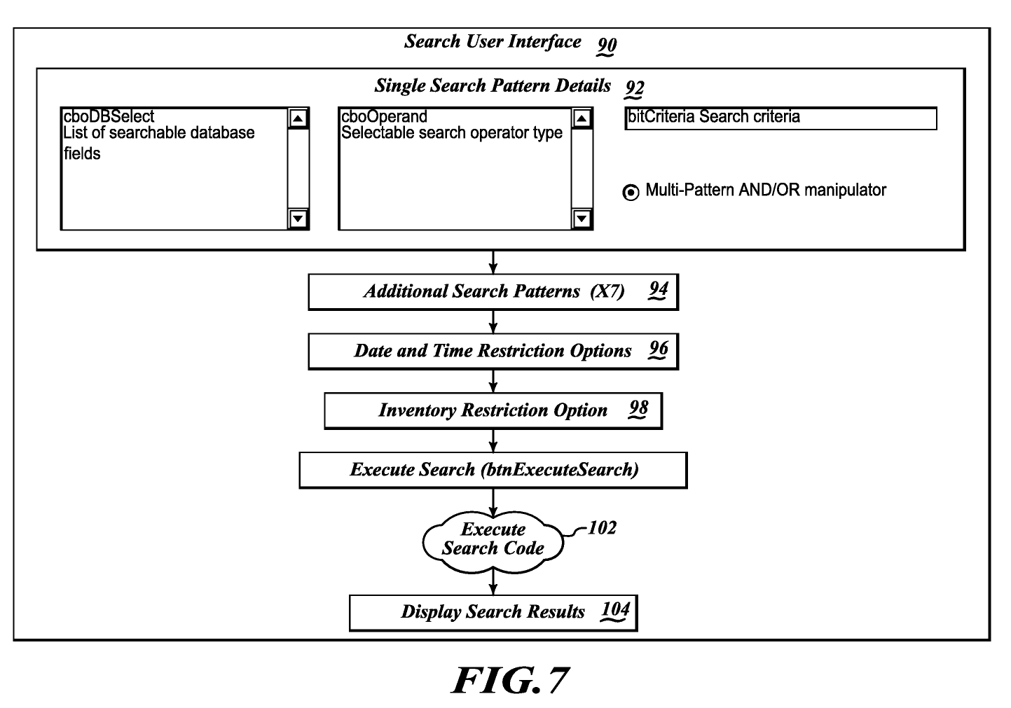

FIG. 7 is an alternate depiction of a flowchart showing the various steps involved in this software invention method of searching a database. There are three major steps shown here, and the first step can have five distinct parts as herein described. The first step 90 has the software displaying the user interface so that the user can enter the search parameters therein; the second part 92 of the first step shows the search pattern details for a single search row; the third part 94 of the first step shows the option for additional input rows (up to seven) for additional fields and pattern operators; the fourth part 96 of the first step offers the options to the user of making date and time restrictions; the fifth part 98 of the first step offers the option to the user of restricting his search to current inventory; the flowchart shows that the user must now click the Execute Search button. The second step 102 comprises the software processing the entered search parameters according to the included algorithms. As previously described, such algorithms manipulate the search parameters (by using predetermined or user-defined row operators to generate a complex search query including search commands and then applying those commands to operate on the stored data in the database) to transform the input data into search results. Lastly, the third step 104 has the software returning the found search results to the user via the user interface.

FIG. 8 shows an interface screen 110 displaying both the input interface 112 with the Impound Search Criteria and the output interface 114 with the Impound Search Results. The Impound Search Criteria options allow the user to build his or her own search request in common English vernacular—without having to understand complex database wildcards and operators. It can be seen that the interface comprises several input rows each having several input fields (in this case database field choices and pattern operator choices and a space for typing in a text string). The Impound Search Results (the output interface) will typically show the results set as a list, either narrow containing only one or a few items or broad containing a range of identified vehicles, and this list may include the database fields chosen in the interface input fields. The output interface could show the results set in any other user-friendly format. As earlier described, the user will have opportunity to print the search results in a report. In various embodiments, these results can be used, e.g., to invoice customers, gather statistics, report to authorities, or simply keep track of inventory.

What is claimed is:

1. A database searching system for managing a search request for a user, comprising:
computer processor means for processing data;
storage means for storing data on a storage medium;
first means for entering search request parameters comprising a flexible user interface having a plurality of input rows, each row containing at least three input fields, the first input field being a chosen database field, the second input field being a chosen pattern operator, and the third input field being a typed text string;
second means for manipulating said input parameters into commands and subsequently applying said commands to operate on the stored data in the database to produce search results; and
third means for returning said search results to the user comprising a user-friendly output interface.

2. The database searching system of claim 1 wherein said first input field of each input row of said flexible user interface of said first means has a drop-down menu presenting several choices to the user, said choices representing the database fields.

3. The database searching system of claim 1 wherein said second input field of each input row of said flexible user interface of said first means has a drop-down menu presenting several choices to the user, said choices representing pattern operators, such as ‘exact match,’ ‘is not,’ and ‘contains.’

4. The database searching system of claim 1 wherein said third input field of each input row of said flexible user interface of said first means has a space for the user to type in a text string.

5. The database searching system of claim 1 wherein said second means comprises a process including a plurality of algorithms that operate on said entered parameters using said entered pattern operators to manipulate said entered data to produce said search results.

6. The database searching system of claim 5 wherein said second means comprises a front-end portion to manipulate said parameters into said commands and a back-end portion to apply said commands to operate on said stored data to produce said search results.

7. The database searching system of claim 1 wherein said third means comprises an output user interface, said interface presenting the found data in user-friendly language and form.

8. The database searching system of claim 7 wherein said user-friendly form includes precise and exact descriptions of the found data.

9. The database searching system of claim 7 further comprising a printed search report.

10. A method of searching a database, comprising the steps of:
entering the search parameters into a flexible user interface comprising a plurality of input rows, each row having at least three input fields;
processing said entered search parameters according to included algorithms that manipulate the search parameters to transform the input data into search results; and
returning the found search results to the user via the user interface.

11. The method of searching according to claim 10 wherein said interface of said entering step presents several choices to a user, including database field choices and pattern operator choices, and also presents a space for typing in a text string.

12. The method of searching according to claim 10 wherein said processing step comprises a plurality of algorithms that operate on said entered search parameters using predetermined row operators to generate a complex search query including search commands.

13. The method of claim 12 wherein said algorithms of said processing step further apply said commands to operate on the stored data in said database.

14. The method of searching according to claim 10 wherein said processing step comprises a front-end portion for generating commands based on said search parameters and a back-end portion for applying said commands to operate on said database.

15. The method of searching according to claim 10 wherein said returning step comprises a user interface for displaying said search results in user-friendly format comprising a list of detailed search results including the database fields chosen in said entering step.

16. The method of claim 15 further comprising the step of printing a search report based on said search results.

17. A database searching system for managing an impound car lot, comprising:
computer processing means for processing data;
storage means for storing data on a storage medium;
first means for entering search request parameters via a user interface comprising a plurality of input rows, each row comprising a plurality of input fields;
second means comprising a plurality of algorithms to operate on said entered search request parameters to locate the user's sought-after information in said database; and
third means for returning said sought-after information to the user in a user-friendly display.

18. The database searching system of claim 17, wherein said input fields of said input rows of said interface are adapted to accept database fields, pattern operators, and free text respectively.

19. The database searching system of claim 18, wherein
said database fields are chosen from a group comprising vehicle data, dispatch data, legal data, and owner data; and
said pattern operators are chosen from a group comprising ‘exact match,’ ‘is not,’ and ‘contains.’

20. The database searching system of claim 19 wherein said user-friendly display includes exact and precise descriptions of the car the user is seeking in the lot as well as the lot location.
